(19) United States
(12) Patent Application Publication
(10) Pub. No.: US 2014/0046740 A1
(43) Pub. Date: Feb. 13, 2014

(54) Dynamic Player Cards

(71) Applicant: Brian Johnson, Seattle, WA (US)

(72) Inventor: Brian Johnson, Seattle, WA (US)

(73) Assignee: YAHOO, INC., Sunnyvale, CA (US)

(21) Appl. No.: 13/572,681

(22) Filed: Aug. 12, 2012

(51) Int. Cl. G06F 3/048; G06Q 30/02

(52) U.S. Cl. 705/14.4; 715/810

(57) ABSTRACT

A system and method for dynamic presentation of a plurality of planar objects includes: generating an interface on a user device, the interface including a display of user-selected interactive features manipulating the planar objects; receiving a selection of a user-selectable interactive feature; and enabling the selected user-selectable interactive feature on the user device.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of on-line interaction, and more particularly relates to the field of on-line interaction of player cards.

### BACKGROUND OF THE INVENTION

The Internet provides a real-world approximation of many social and gaming activities. Traditional games such as checkers, chess, solitaire and Scrabble® are wonderfully simulated on the Internet, allowing a range of user engagement that closely approximates a “real” game. These games can even be played with other on-line players who may themselves be approximating “real” players. The shortcomings of these games, however, are the inability to interact with the “pieces” in a meaningful way. For example, other than changing the basic look of a card or board piece, there exist no options for a user to engage with the game pieces.

There is a need for a system and method that allows a more enriching engagement with on-line objects.

### SUMMARY OF THE INVENTION

Briefly, according to an embodiment of the invention, a method for dynamic presentation of a plurality of planar objects includes steps or acts of: generating an interface on a user device, the interface including a display of user-selectable interactive features for manipulating the planar objects; receiving a selection of the user-selectable interactive feature; and enabling the selected user-selectable interactive feature on the user device.

According to another embodiment of the present invention, an on-line system for dynamic presentation of a plurality of planar objects includes: a memory with computer-executable instructions; and a processor device operably coupled with the memory. The computer-executable instructions include: generating an interface on a user device, the interface including a display of user-selectable interactive features for manipulating the planar objects; receiving a selection of the user-selectable interactive feature; and enabling the selected user-selectable interactive feature on the user device.

According to another embodiment of the present invention, a computer program product includes a non-transitory computer readable medium with computer-executable instructions stored therein. The computer-executable instructions cause a computer to perform steps of: generating an interface on a user device, the interface including a display of user-selectable interactive features for manipulating the planar objects; receiving a selection of the user-selectable interactive feature; and enabling the selected user-selectable interactive feature on the user device.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is an exemplary screenshot of player cards shown face up, according to an embodiment of the present invention;

FIG. 2 is an exemplary screenshot of the player cards of FIG. 1 shown face down, according to an embodiment of the present invention;

FIG. 3 is an exemplary screenshot of the Options tab for selectable features, shown in the closed position, according to an embodiment of the present invention;

FIG. 4 is an exemplary screenshot of the Options tab for selectable features, shown in the open position, according to an embodiment of the present invention;

FIG. 5 is a high-level flowchart of providing dynamic player cards, according to an embodiment of the present invention;

FIG. 6 is an exemplary illustration of how advertising can be incorporated into a player card, according to an embodiment of the present invention;

FIG. 7 shows a simplified block diagram of a virtual card system in which dynamic player cards can be implemented, according to an embodiment of the present invention; and

FIG. 8 shows a simplified block diagram of an apparatus configured to operate according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

We describe an on-line dynamic presentation of player cards that does not yet exist in the on-line world. We present virtual player cards with which a user can interact as though in a real-world setting with physical cards. The Player cards encourage user interaction, incentivize their site participation and create a new avenue for advertisers.

The implementation and technology we enable in this disclosure can be used for any planar object (photos, posters, cards, and the like). For simplicity, our examples show cards; however, this should not be deemed to restrict the invention to these particular embodiments, as the examples shown are for the purpose of enabling those with knowledge in the art to understand and use the invention.

The presentation is scaled to meet the ability of whatever browser is viewing the cards. For example, currently, Internet Explorer does not support many of the new CSS properties used in the modeling of the cards; therefore Internet Explorer provides a very basic presentation. Google Chrome, Safari, Firefox, and Opera, among others, have the capabilities to provide an elaborate and engaging presentation.

In one embodiment of the present disclosure, the virtual player cards are traded just as a user would trade a player in any fantasy sports game, and similar to the manner in which Pokémon™ cards are traded. In another embodiment players win “medals” for achieving certain goals during fantasy games. Instead (or in addition to) these medals, players can also acquire exclusive player cards. Players are able to acquire cards by joining leagues, trading, and winning achievements.

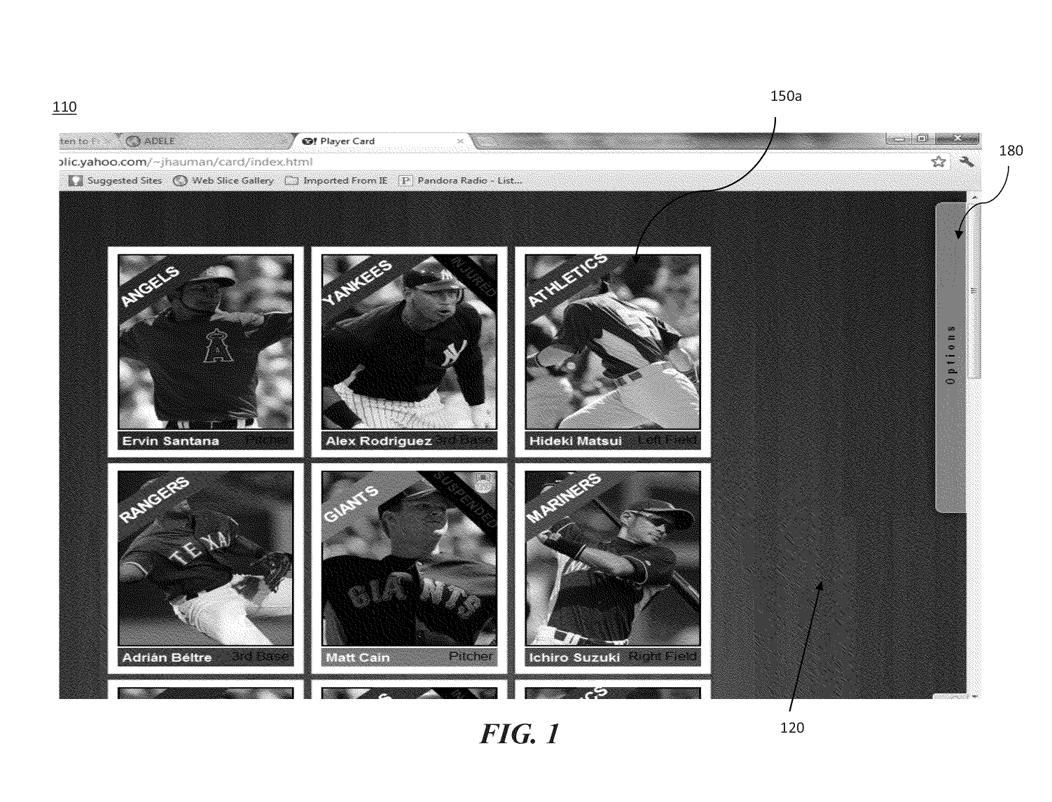

We use CSS3 (Cascading StyleSheets 3), a stylesheet language used for setting up the look and formatting of a web document. However, it is to be expected that any stylesheet language that provides the features needed, whether in current use or contemplated for future development, can be used within the spirit and scope of the invention. We provide a model (shown in FIGS. 1 through 4) using entirely CSS3 and HTML (hyper-text mark-up language). Using just these two tools, our dynamic player cards provide a three-dimensional analog to physical player cards. We allow rotation of the cards, stacking, and a number of additional animations to encourage user interaction and involvement. We also provide a portal for trading the player card with other on-line users.

This implementation has been made with reverse compatibility (older browsers retain a usable experience) and enhancements for more capable browsers, including mobile devices such as the iPhone, iPad, and the Android. We provide a backdrop for the player cards that does more than just provide a visual background. This backdrop in the display provides space for advertising, creating a new avenue for advertisers.

Using standard HTML markup, mobile applications and online site components we can easily and quickly integrate a “stack” of virtual player cards. These cards can have intuitive interactions that mimic physical player cards, such as 3D rotations and ability to “stack” them. This interaction can be made entirely with CSS3 (with only basic changes made via JS changing class names).

Different interactive features can quickly be enabled or disabled either by editors finely tuning the experience or by end users who wish to view their cards in a specific way. These features can include “zooming,” artificial card wear, drop shadows, and more. The presentation is also fully capable of working on iPhone, iPad, and Android devices—making them fully capable of being integrated into stand-alone applications.

As cards can be entirely dynamic, users may be able to collect series of virtual cards just as people have collected baseball cards for years. Their interactions are unprecedented and offer a unique, new and engaging way to interact—giving incentive to both collect cards and engage directly with the content. One way to engage with the content is for a user to click on any card to flip it over. The “flip side” of the card reveals ancillary information such as a player's stats, hometown, and the like. Here you will find information not included in the primary display.

Referring now to the drawings in general and to FIG. 1 in particular, we show the interactive display 110 featuring player cards 150 against a backdrop 120 that provides space for advertising. The player cards 150 in this example are shown face up 150a. The cards 150a look identical to actual playing cards, with the player's image and team colors prominently featured. An Options tab 180 is shown on the right-hand side of the display. This tab 180 is purposely kept “tucked away” when it is not needed. When a user wishes to change or select options for interacting with the cards 150, the user can simply hover over, or click on the tab 180.

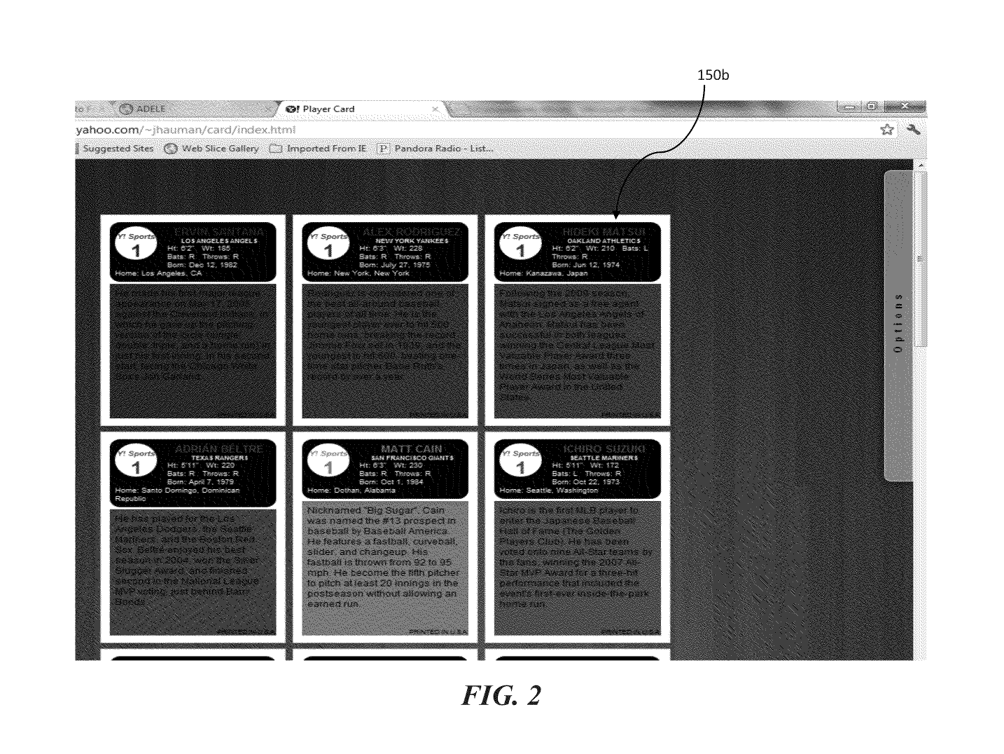

FIG. 2 shows the player cards 150 of FIG. 1, in a face down position 150b. The player cards 150b reveal the kind of information that one would normally expect to see on the back of a player card. Information such as the player's home town and statistics are shown.

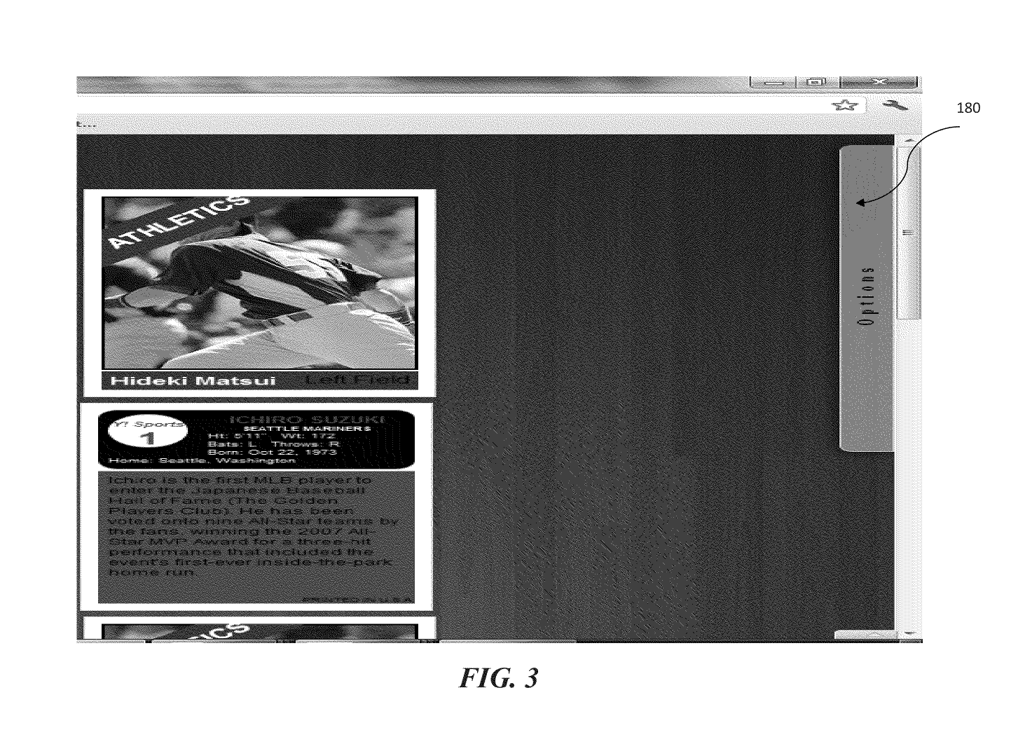

FIG. 3 is a zoomed-in screenshot of the Options tab 180 in the closed position, according to an embodiment of the present invention.

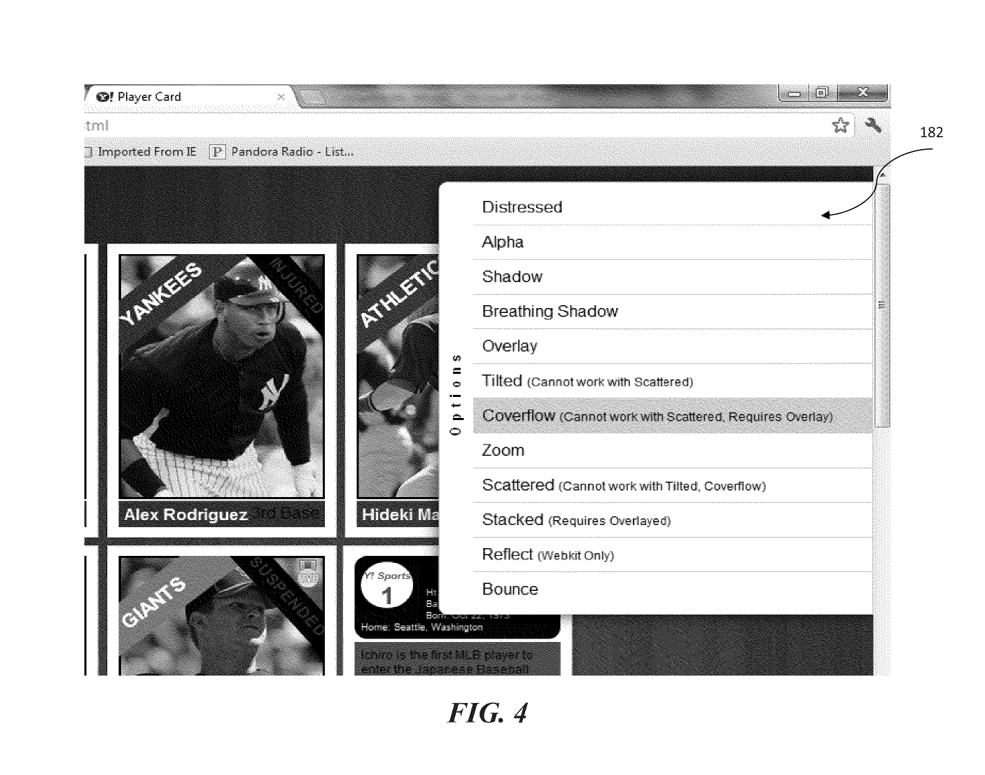

FIG. 4 is a zoomed-in screenshot of the Options tab 182 in the open position, according to an embodiment of the present invention. The Options listed are:

Distressed—provides an “aged” appearance to the cards.

Alpha—with this feature enabled, the cards become opaque until they are “active” (clicked on or hovered over).

Shadow—with this feature enabled, the active card appears to be lifted off the surface, in a faux three dimensional (3D) space. Basically, when you hover over a card, it draws a shadow around it so that the card pops out a bit and looks like it is being “picked up” off the background.

Breathing Shadow—with the feature enabled, the shadow around the active card will pulsate slowly, drawing a subtle cue to its ability for interaction.

Overlay—tiles the cards.

Tilted—tilts the cards.

Coverflow—with this feature enabled, the cards can be titled and tiled.

Zoom—with this feature enabled, the active card zooms in and out.

Scattered—with this feature enabled, the cards are displayed haphazardly

Stack—with this feature enabled, only the top card in the “stack” or “deck” of cards is shown.

Bounce—with this feature enabled, the active card appears to “bounce.”

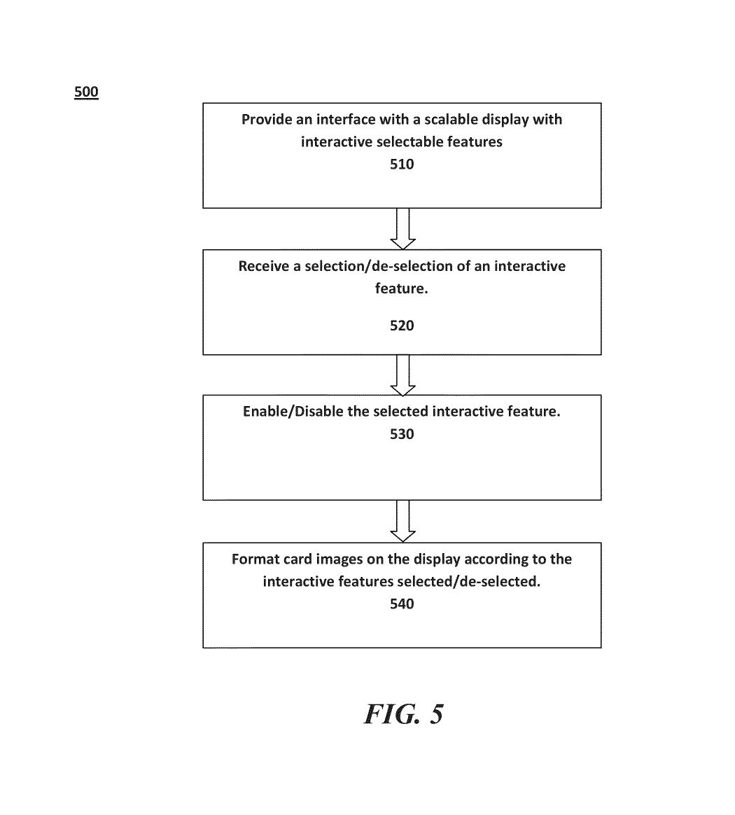

FIG. 5 is a high-level flowchart 500 of a method for providing dynamic player cards 150, according to an embodiment of the present invention. In step 510 we provide a dynamic interface that presents a display providing user-selectable features for the playing cards 150. The players can stack the cards, show them, and hide them. This interface also enables for players to “trade” cards with other players.

In step 520 we receive a selection or a de-selection of a selectable feature for presenting and/or manipulating the cards 150. Some of the features operate on all of the cards, when enabled; whereas other features only operate on the “active” card. We consider a card “active” when the user has selected it, either by clicking on it or hovering over it.

A selection of a feature is accomplished differently, according to the selection means available on the user's device. For example, if the user is using a touch-screen, the features can be selected by touch. If the user is not using a touch-screen, the features are selected by mouse-clicks. Once a feature is selected, it will display an indication such as a checkmark or a highlighting, blinking, or the like. In our exemplary screenshots, we show a checkmark to indicate which features have been selected. Other indicators are contemplated within the spirit and scope of the invention.

In step 530 we enable or disable the features, as indicated by the user. Selecting a non-checked feature will enable that feature; conversely, selecting a checked feature will disable it.

In step 540, using CSS3 we format the card images 150 on the display 110 according to the selection/de-selection of the features. For example if the user selected the “stack” option, the cards are presented in a “stack” with only the top card showing.

Monetizing.

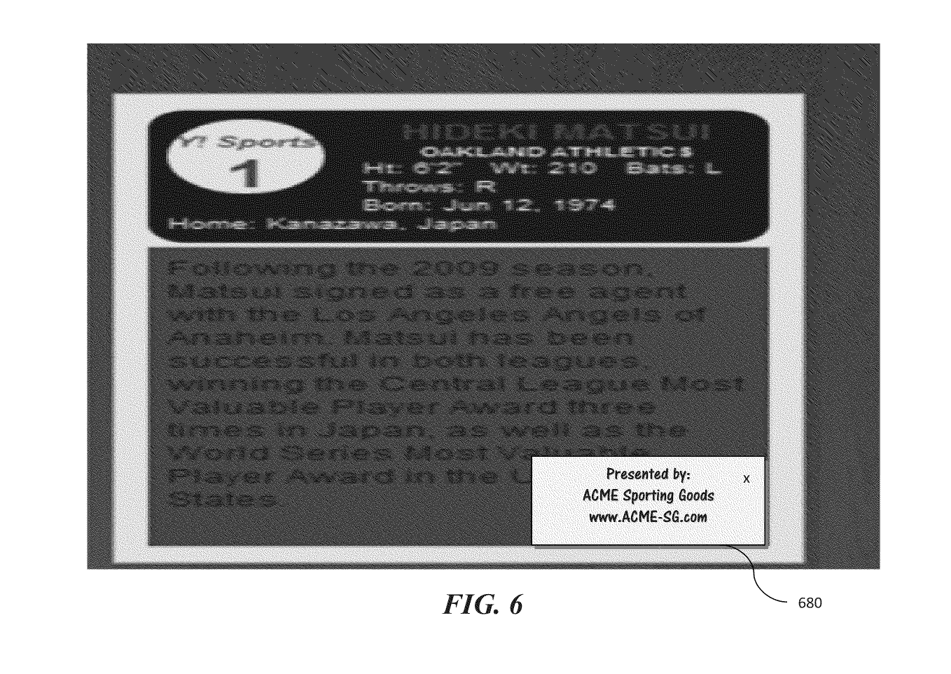

Referring now to FIG. 6, we show an example where an advertisement 680 is placed on the back side of a card. The advertising can also be placed within the backdrop of the playing cards 150 which can provide a larger space for a banner ad.

User Interface.

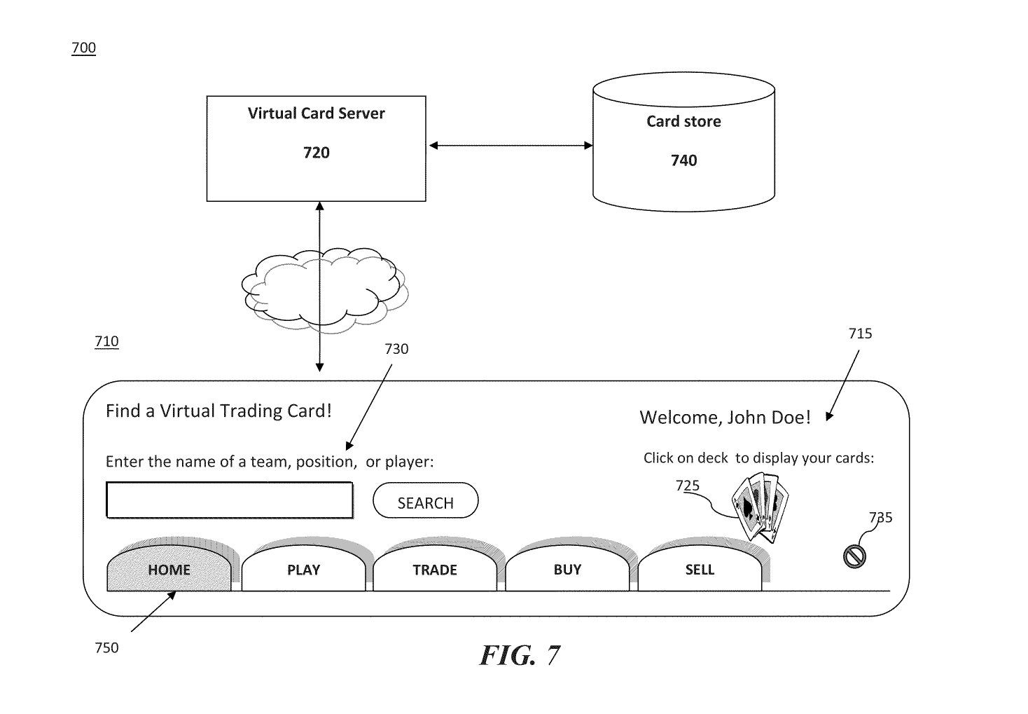

Referring to FIG. 7 we show a system 700 in which dynamic player cards can be implemented, according to an embodiment of the present invention. The Virtual Card Server 720 is operably coupled with a Card Store 740. The Card Store 740 is data storage that may reside in the Server 720 or is kept remotely, accessible via a network, such as the Internet. The Virtual Card Server 720 generates a dynamic user interface 710 for playing cards. We only show the top portion of the interface 710 here. The look and feel of the interface 710 can be quite varied and can conform to the screen attributes of the device on which it will be displayed. In FIG. 7 we show one style that is quite similar to the look and feel of many popular websites, just for simplicity and to show the use of the invention only. The interface according to the invention is not limited to this exemplary representation. FIG. 7 features a welcome section 715 welcoming the registered user. This assumes the user has already logged in to his/her player account. Multiple action tabs 750 are shown, reflecting the different types of activities that are possible with the dynamic player cards.

The “Home” tab 750 is the currently active tab in this illustration. This is the first page the player sees after logging in. A “Welcome” 715 is presented to the player along with an icon 725. Selecting this icon 725 presents the player's cards 150. Note that this icon is not restricted to the Home page and can appear on all pages of the site. A “Hide” icon 735 can also be activated when the player wishes to conceal his/her cards 150. The cards 150 are stored in storage 740 until retrieved by the Virtual Card Server 720. All commands entered on the interface 710 are received by the Virtual Card Server 720 through the Internet. Those with knowledge in the art will appreciate that commands sent from a mobile device will be routed through a mobile app gateway.

The “Play” tab 750 directs the player to a pseudo play table with a backdrop 120 that can be customized by the player. Here the player can select the Options 180 as previously discussed. The “Trade” tab 750 directs the player to an on-line trading page. The “Buy” and “Sell” tabs 750 direct the player to an on-line marketplace where the player is able to buy and sell trading cards 150.

Hardware Embodiment.

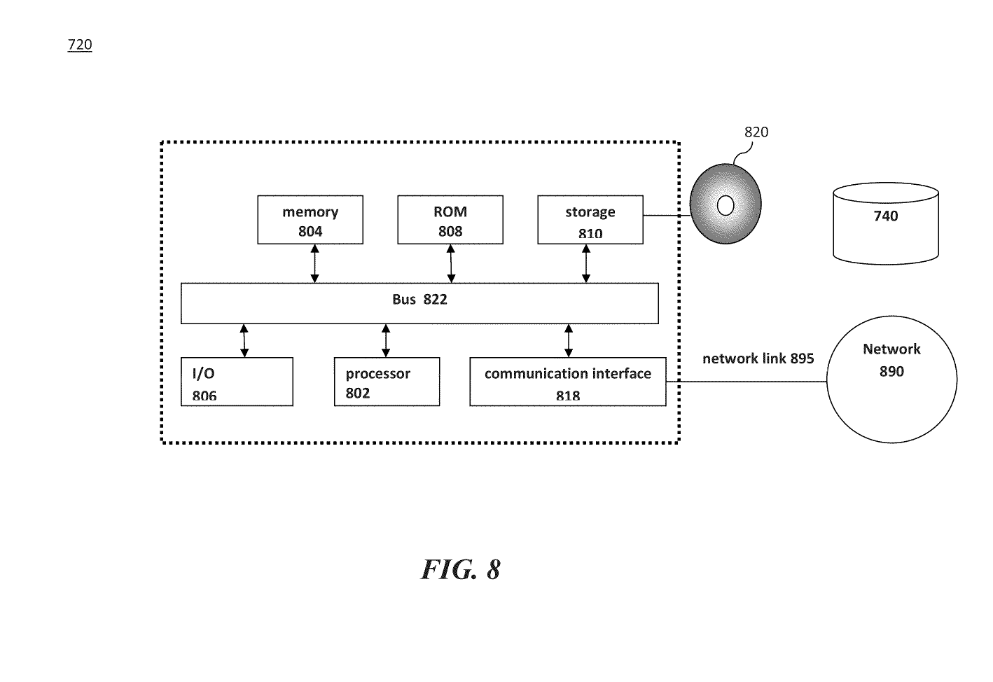

Referring now in specific detail to FIG. 8, there is provided a simplified high-level block diagram of an information processing system such as the Virtual Card Server 720 in which the present invention may be implemented. For purposes of this invention, computer system 720 may represent any type of computer, information processing system or other programmable electronic device, including a client computer, a server computer, a portable computer, an embedded controller, a personal digital assistant, and so on. The computer system 720 may be a stand-alone device or networked into a larger system. Computer system 720, illustrated for exemplary purposes as a networked server, is in communication with other networked computing devices (not shown) via network link 890. As will be appreciated by those of ordinary skill in the art, network 890 may be embodied using conventional networking technologies and may include one or more of the following: local area networks, wide area networks, intranets, public Internet and the like.

In general, the routines which are executed when implementing these embodiments, whether implemented as part of an operating system or a specific application, component, program, object, module or sequence of instructions, will be referred to herein as computer programs, or simply programs. The computer programs typically comprise one or more instructions that are resident at various times in various memory and storage devices in an information processing or handling system such as a computer, and that, when read and executed by one or more processors, cause that system to perform the steps necessary to execute steps or elements embodying the various aspects of the invention.

Throughout the description herein, an embodiment of the invention is illustrated with aspects of the invention embodied solely on computer system 720, for simplicity. As will be appreciated by those of ordinary skill in the art, aspects of the invention may be distributed among one or more networked computing devices which interact with computer system 720 via one or more data networks such as, for example, network 890. However, for ease of understanding, aspects of the invention have been described as embodied in a single computing device—computer system 720.

Computer system 720 includes processing device 802 which communicates with an input/output subsystem 806, memory 804, storage 810 and network 890. The processor device 802 is operably coupled with a communication infrastructure 822 (e.g., a communications bus, cross-over bar, or network). The processor device 802 may be a general or special purpose microprocessor operating under control of computer program instructions executed from memory 804 on program data. The processor 802 may include a number of special purpose sub-processors such as a comparator engine, each sub-processor for executing particular portions of the computer program instructions. Each sub-processor may be a separate circuit able to operate substantially in parallel with the other sub-processors.

Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips.

The memory 804 may be partitioned or otherwise mapped to reflect the boundaries of the various memory subcomponents. Memory 804 may include both volatile and persistent memory for the storage of: operational instructions for execution by processor device 802, data registers, application storage and the like. Memory 804 may include a combination of random access memory (RAM), read only memory (ROM) and persistent memory such as that provided by a hard disk drive. The computer instructions/applications that are stored in memory 804, such as instructions for implementing the steps of FIG. 5, are executed by processor 802. The computer instructions/applications and program data can also be stored in hard disk drive 810 for execution by processor device 802. Card Store 740 pictured here is a representation of storage for the virtual cards 150 and may be a plurality of databases operably coupled with a server network 890 such as the Internet through network link 895.

Those skilled in the art will appreciate that the functionality implemented within the blocks illustrated in the diagram may be implemented as separate components or the functionality of several or all of the blocks may be implemented within a single component. The I/O subsystem 806 may comprise various end user interfaces such as a display, a keyboard, and a mouse. The I/O subsystem 806 may further comprise a connection to a network 890 such as a local-area network (LAN) or wide-area network (WAN) such as the Internet.

The computer system 720 may also include storage 810, representing a magnetic tape drive, an optical disk drive, a CD-ROM drive, and the like. The storage drive 810, which can be removable, reads from and/or writes to a removable storage unit 820 in a manner well known to those having ordinary skill in the art. Removable storage unit 820, represents a compact disc, magnetic tape, optical disk, CD-ROM, DVD-ROM, etc. which is read by and written to by removable storage drive 810. As will be appreciated, the removable storage unit 820 includes a non-transitory computer readable medium having stored therein computer software and/or data for implementing the real-time feedback collection system.

The computer system 720 may also include a communications interface 818. Communications interface 818 allows software and data to be transferred between the computer system and external devices. Examples of communications interface 818 may include a modem, a network interface (such as an Ethernet card), a communications port, a PCMCIA slot and card, etc. Software and data transferred via communications interface 818 are in the form of signals which may be, for example, electronic, electromagnetic, optical, or other signals capable of being received by communications interface 818.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A method for dynamic presentation of a plurality of planar objects, comprising:
using a processor device operably coupled with a memory, said memory comprising computer-executable instructions performing:
generating an interface on a user device, said interface comprising a display of user-selectable interactive features manipulating the planar objects;
receiving a selection of a user-selectable interactive feature; and
enabling the selected user-selectable interactive feature on the user device.

2. The method of claim 1 further comprising:
receiving a de-selection of a user-selectable interactive feature; and
disabling the de-selected user-selectable interactive feature on the user device.

3. The method of claim 2 further comprising:
receiving a request for images of the plurality of planar objects;
providing the images of the planar objects on the display, wherein the images are presented against a backdrop.

4. The method of claim 3 wherein the selection of the user-selectable interactive feature comprises an image formatting feature and the method further comprises:
formatting the images according to the image formatting feature.

5. The method of claim 4 wherein the image formatting feature comprises a bounce effect.

6. The method of claim 4 wherein the image formatting feature comprises a tiled effect.

7. The method of claim 4 wherein the image formatting feature comprises a shadow effect.

8. The method of claim 1 further comprising scaling the display according to an ability of a browser used to view said display.

9. The method of claim 3 further comprising providing an advertisement on the backdrop.

10. The method of claim 3 further comprising providing an advertisement on the images.

11. An on-line system for dynamic presentation of a plurality of planar objects, comprising:
a memory with computer-executable instructions stored therein, said computer-executable instructions comprising:
generating an interface on a user device, said interface comprising a display of user-selectable interactive features manipulating the planar objects;
receiving a selection of a user-selectable interactive feature; and
enabling the selected user-selectable interactive feature on the user device; and
a processor device operably coupled with the memory.

12. The on-line system of claim 11 wherein the computer-executable instructions further comprise:
receiving a de-selection of a user-selectable interactive feature; and
disabling the de-selected user-selectable interactive feature on the user device.

13. The on-line system of claim 12 wherein the computer-executable instructions further comprise:
receiving a request for images of the plurality of planar objects;
providing the images of the planar objects on the display, wherein the images are presented against a backdrop.

14. The on-line system of claim 13 wherein the selection of the user-selectable interactive feature comprises an image formatting feature and the computer-executable instructions further comprise:
formatting the images according to the image formatting feature.

15. The on-line system of claim 14 wherein the image formatting feature comprises a bounce effect.

16. The on-line system of claim 14 wherein the image formatting feature comprises a tiled effect.

17. The on-line system of claim 14 wherein the image formatting feature comprises a shadow effect.

18. The on-line system of claim 13 further comprising serving an advertisement on the backdrop.

19. The on-line system of claim 13 further comprising serving an advertisement on the images.

20. A computer program product comprising a non-transitory computer-readable storage medium with computer-executable instructions stored therein, said computer-executable instructions comprising:
generating an interface on a user device, said interface comprising a display of user-selectable interactive features manipulating the planar objects;
receiving a selection of the user-selectable interactive feature; and
enabling the selected user-selectable interactive feature on the user device.
